(19) United States
(12) Patent Application Publication
(10) Pub. No.: US 2023/0192465 A1
(43) Pub. Date: Jun. 22, 2023

(54) AUTOMATED METHOD FOR DISTRIBUTING CLOSURE ELEMENTS

(71) Applicant: ETABLISSEMENTS ANDRE ZALKIN ET CIE, Montreuil L'Argille (FR)

(72) Inventor: Laurent STAELENS, Montreuil L'Argille (FR)

(21) Appl. No.: 17/925,069

(22) PCT Filed: May 10, 2021
(86) PCT No.: PCT/FR2021/050799

§ 371 Date: Nov. 14, 2022

(30) Foreign Application Priority Data
May 19, 2020 (FR) FR2005094

(51) Int. Cl. B67B 3/064; B25J 9/00; B25J 9/16; B65G 43/08; B65G 47/14

(52) U.S. Cl. CPC B67B 3/064; B25J 9/0018; B25J 9/0087; B25J 9/0093; B25J 9/1697; B65G 43/08; B65G 47/1457; B65G 2203/041; B65G 2203/0241

(57) ABSTRACT

An automated method for distributing closure elements with screwing and/or stopping means structure, comprising including supplying a turntable with a plurality of closure elements arranged on the turntable, including detecting the format of each closure element arranged on the turntable and gripping each closure element for which the format has been detected in order to distribute it to a transfer device capable of transporting a plurality of closure elements with screwing and/or stopping structure.

### TECHNICAL FIELD

The present invention relates to the field of packaging, and more particularly, systems for distributing closure elements for bottles.

### BACKGROUND

Mention may be made, without limitation, as closure elements, of plastic caps or corks. In general, it is any object intended to ensure the closure of a container.

These closure elements are transported with screwing or stopping means to carry out the various operations necessary to obtain a finished product such as a filled and closed bottle.

In order to supply the screwing or stopping means with closure elements, the latter begin by circulating on a first conveyor, which comprises, in a conventional manner, lifting hoppers capable of transporting the closure elements to an orientation conveyor intended to orient them and distribute them to transfer means.

More particularly, the transfer means are capable of transporting the closure elements to the screwing or stopping means and generally include a set of cells or mechanical traps, intended to accommodate, in each cavity, a closure element.

This allows the screwing or stopping means to receive a defined number of closure elements on which they perform operations such as screwing or stopping bottles.

In order to orient the closure elements, linear conveyors intended to be supplied with closure elements have been developed.

On either side of these conveyors, cameras are arranged ensuring the detection of the closure elements transported by the linear conveyors so that the gripping means can grip them and distribute them to the transfer means.

However, when the closure elements placed on the linear conveyors are not gripped, they must again be detected by the cameras.

For this purpose, recycling conveyors are used to put the closure elements not gripped back into the lifting hopper. The congestion of the transmission line is increased.

In order to eliminate the use of recycling conveyors, linear conveyors have been replaced by rotary conveyors comprising turntables, also capable of ensuring high speeds.

Thus, the closure elements not gripped remain arranged on the turntable until they are distributed to the transfer means.

However, these rotary conveyors are designed to grip closure elements having a single packaging format defined prior to the assembly of the rotary conveyor, the format corresponding to the dimensions of the closure element.

In other words, these rotary conveyors become inoperative when the closure element format changes.

More particularly, the modification of the format requires carrying out new tests and calculations on the system, in the laboratory.

Indeed, when changing a closure element format, it is necessary to change the shape of the transfer means so that they can accommodate closure elements in each cavity.

To obtain a format of the transfer means adapted to the format of the closure elements, a series of calculations and tests must be carried out again in the laboratory to determine the appropriate shape of the transfer means.

Moreover, the shape thus determined is generally only adapted for a defined closure element format.

Thus, as soon as the format of the closure element arranged on the rotary conveyor changes, it is necessary to mechanically remove the transfer means adapted to the previous format and to replace them with transfer means adapted to the new format of the closure element, which can be slow and tedious to perform.

### SUMMARY

The object of the invention is therefore to overcome the aforementioned disadvantages and to propose an automated closure element distribution system capable of adapting to changes in closure element format.

To this end, provision is made of an automated method for distributing closure elements with screwing and/or stopping means.

The method comprises supplying a turntable with a plurality of closure elements arranged on the turntable, detecting the format of each closure element arranged on the turntable and gripping each closure element for which the format has been detected in order to distribute it to transfer means capable of transporting a plurality of closure elements with screwing and/or stopping means.

In order to transport the closure elements of different formats with screwing and/or stopping means, the closure elements are first arranged in bulk on the turntable.

The rotation of the table allows the closure elements to be presented, as many times as necessary, to the vision system, so that it can detect their format in order to be able to distribute them to transfer means capable of transporting a plurality of closure elements with screwing and/or stopping means.

Similarly, when gripping means are gripping and/or transporting closure elements, the other closure elements, arranged on the turntable, can again be presented to the gripping means so that they can grip them as soon as they will be free.

Thus, once the format of the closure element has been detected, the gripping means perform translation and/or rotation movements in order to be able to grip the closure element.

Advantageously, the method further comprises an orientation of the closure elements arranged on the turntable according to a predefined profile.

In order to grip the closure elements, it is advantageous that they are arranged on the turntable according to a particular profile.

For example, when it comes to screwing the closure elements onto bottles, it is advantageous to orient only the closure elements which are substantially oriented towards the opposite direction of the screwing of the bottle so that each is arranged in an indexed position in the transfer means intended to transport said closure elements to a screwing turret.

Preferably, the turntable is supplied by the plurality of closure elements when the number of closure elements arranged on at least one surface of the turntable is less than a predetermined threshold.

In order to maintain a constant loading rate of closure elements on the turntable, the detected closure elements are counted and if the number of closure elements is less than a predetermined threshold, for example 30% of the number of closure elements that the total surface of the table is able to accommodate, the turntable is again supplied with a plurality of closure elements, for example until a loading rate of 70% is obtained, for example.

“Predetermined threshold” can also be understood as a number of closure elements defined according to a specific surface of the turntable.

Thus, in this example, it is a question of a number of closure elements 30% less than that which can be accommodated by a determined surface of the turntable, the surfaces of the turntable being distributed in a homogeneous manner.

Alternatively, the turntable is supplied with a plurality of closure elements when the total surface area covered by the closure elements arranged on at least one surface of the turntable is less than a predetermined threshold.

This allows, when a plurality of closure elements are close to each other and therefore difficult to delimit, to be able to determine the rate of loading a surface of the turntable by the closure elements.

By way of example, by measuring the surface area of the closure elements arranged in a delimited surface area of the turntable, thanks to their colour, the loading rate of the turntable is determined by comparing the total surface area covered by the closure elements with a threshold value.

In other words, when the measured surface is, for example, 30% less than the delimited surface of the turntable, the turntable is supplied with a plurality of closure elements.

Alternatively, the turntable is supplied cyclically.

For example, for a rate of 120 closure elements per minute, it is possible to choose to supply the turntable with a plurality of closure elements every 30 seconds.

Preferably, the transfer means are initially in a reference position which are oriented by a reference angle relative to their reference position when they include a predefined number of closure elements, other transfer means to be filled being simultaneously arranged in said reference position.

In order to ensure a defined and constant work rate, it is advantageous to substitute transfer means including a predefined number of closure elements by other empty transfer means so that they can be supplied.

By way of example, as soon as all the cells are filled with closure elements, the first set of cells pivots according to a reference angle, for example 180°, so that a second set of empty cells can be placed in the initial reference position of the first set of cells.

Advantageously, the detection comprises a capture of an image of each closure element and a submission of the image to a classification algorithm able to select the format of the closure element from a set of possible reference formats.

The classification algorithm can be a classifier or a meta-classifier capable of recognising the format of a closure element from a list of reference formats.

If the format is new, in other words, not comprised in the list of reference formats, an operator can train the classification algorithm to recognise said format by providing it with the closure element image as input.

Alternatively, the detection comprises capturing an image of each closure element and submitting the image to an image recognition algorithm able to detect a single closure element format.

In other words, it is a question of locating only the closure elements having a specific format defined by the image recognition algorithm. These closure elements are distributed to the transfer means.

Otherwise, the closure elements continue to circulate on the turntable until the operator has updated the image recognition algorithm, so as to recognise the format of these closure elements.

According to another aspect, the object of the invention is an automated system for distributing closure elements with screwing and/or stopping means, comprising supply means able to supply a turntable with a plurality of closure elements.

The system comprises:
detection means capable of detecting the format of each closure element arranged on the turntable;
gripping means capable of gripping each closure element for which the format has been detected and placing it in transfer means capable of transporting a plurality of closure elements with screwing and/or stopping means.

Advantageously, the system comprises orientation means capable of positioning the closure elements arranged on the turntable according to a predefined profile.

Preferably, the orientation means include a comb and a flap arranged opposite each other.

Preferably, the supply means are capable of supplying the turntable with a plurality of closure elements, when the number of closure elements, arranged on at least one surface of the turntable, is less than a predetermined threshold.

Alternatively, the supply means are capable of supplying the turntable with a plurality of closure elements, when the total surface area covered by the closure elements arranged on at least one surface of the turntable is less than a predetermined threshold.

Alternatively, the supply means are capable of cyclically supplying the turntable with the plurality of closure elements.

Advantageously, the transfer means are initially in a reference position, the system comprising control means able to orient the transfer means by a reference angle relative to their reference position when they include a predefined number of closure elements, and simultaneously have other transfer means to be loaded in a reference position.

Preferably, the system comprises a calculation module, and the detection means include at least one camera capable of capturing an image of a closure element, and submitting it to the calculation module capable of selecting, by executing a classification algorithm, the closure element format from a set of possible reference formats.

In another implementation, the system comprises a calculation module, and the detection means include at least one camera capable of capturing an image of a closure element, and submitting it to the calculation module capable of detecting, by executing an image recognition algorithm, a single closure element format.

Preferably, the gripping means include a suction cup and a centring jig, or an electric or pneumatic gripper.

Advantageously, the supply means include a lifting hopper and at least one conveyor capable of cooperating with the turntable.

### BRIEF DESCRIPTION OF THE DRAWINGS

Other purposes, features and advantages of the invention will appear upon reading the following description, given only by way of non-limiting example, and made with reference to the appended drawings on which:

FIG. 1 schematically illustrates an automated closure element distributing system according to one embodiment of the invention;

FIG. 2 schematically shows means for orienting closure elements arranged on a turntable according to one embodiment of the invention and,

FIGS. 3A-3C illustrate different implementations of the orientation means.

### DETAILED DESCRIPTION

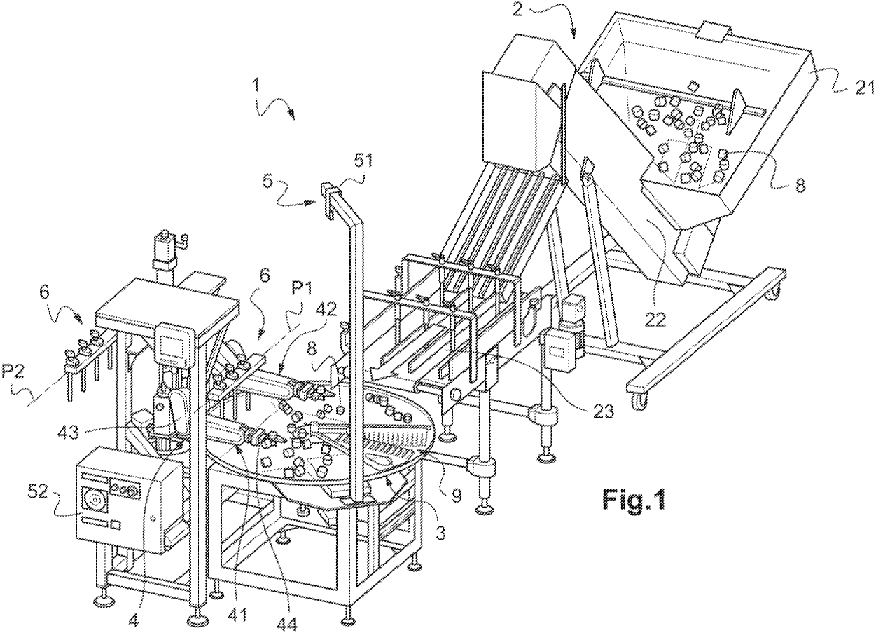

FIG. 1 shows a closure element distribution system 8, designated by the general reference numeral 1.

The closure elements 8, for example capsules or pumps, can be in different formats or in a single format.

The distribution system 1 is intended to transport the closure elements 8 with screwing and/or stopping means capable of carrying out the operations necessary to obtain a finished product, for example a filled and closed bottle.

For this purpose, the distribution system 1 comprises transfer means 6 capable of transporting a plurality of closure elements 8 with screwing and/or stopping means.

To supply the transfer means 6 with a plurality of closure elements 8, the distribution system 1 includes supply means 2 capable of transporting, along a predetermined path, the closure elements 8 arranged in trays 21.

More particularly, this is a lifting hopper 22 and a conveyor 23 capable of cooperating.

The conveyor 23 is here linear, but this does not exclude the use of conveyors whose shape follows a different geometric path.

Of course, the conveyor 23 can be, without limitation, a roller conveyor, a pilgrim step or screw conveyor. It is any type of conveyor capable of transporting closure elements.

The distribution system 1 further includes a turntable 3, able to cooperate with the conveyor 23, and on which the closure elements are arranged in bulk and in excess, which allows them to be presented, as many times as necessary, to gripping means 4 arranged around the turntable 3.

In other words, the closure elements 8 not gripped by the gripping means 4 on the turntable 3 will again be presented to the detection means 5 thanks to the rotation of the turntable 3.

Thus, the closure elements 8 not gripped remain arranged on the turntable 3 until they are gripped by the gripping means 4.

The turntable 3 therefore allows to avoid having to use recycling conveyors comprising, for example, other conveyors in order to put the closure elements 8 back into the turntable 3.

Moreover, the gripping means 4 here include two robots 41 and 42 capable of gripping the closure elements 8 and transporting them to the transfer means 6.

Each robot 41, 42 consists of an actuator 43 coupled to an effector 44, the end of which includes a suction cup and a centring jig.

Alternatively, the end of the effector 44 may include an electric or pneumatic gripper.

As each closure element 8 can have a particular format. It is advantageous to detect it so that the effector 44 can grasp it.

For this purpose, the distribution system 1 comprises detection means 5 capable of detecting the format of each closure element 8 arranged on the turntable 3.

More particularly, the detection means 5 include at least one camera 51 capable of capturing an image of a closure element 8 circulating in its field of vision and submitting it to a calculation module 52.

The calculation module 52 can be implemented in a microprocessor or a microcontroller.

It is capable of executing a classification algorithm to select the format of the closure element 8 whose image has been submitted thereto, from a set of possible reference formats.

Alternatively, the calculation module 52 is capable of executing an image recognition algorithm capable of detecting a single closure element format 8.

If the format is new, in other words not stored in a memory of the calculation module 52, an operator can train the image classification or recognition algorithm to recognise it, by providing as input to the algorithm, the image closure element 8.

Moreover, so that the gripping means 4 can grip the closure elements 8, it is advantageous for them to be arranged on the turntable according to a profile determined according to the operation to be performed, such as screwing or closure.

For this purpose, the distribution system 1 comprises orientation means 9 able to orient all the closure elements arranged in bulk in the turntable 3.

The closure elements 8 for which the format has been detected and which are arranged according to said profile, will therefore be gripped and placed in the transfer means 6.

More particularly, the transfer means 6 are initially in an initial reference position P1, here a set of cells, each intended to accommodate a closure element 8 gripped by the gripping means 4.

In this example, when all the cells are loaded with closure elements 8, control means, not shown here, orient the transfer means 6 by a reference angle, here 180°, relative to its initial reference position P1. The set of cells is thus in position P2.

The control means then have, during the orientation of the set of cells from position P1 to position P2, another set of empty cells capable of being supplied with closure elements in the initial reference position P1.

It should be noted that the control means can be implemented in the same microprocessor or microcontroller wherein the calculation module 52 is integrated.

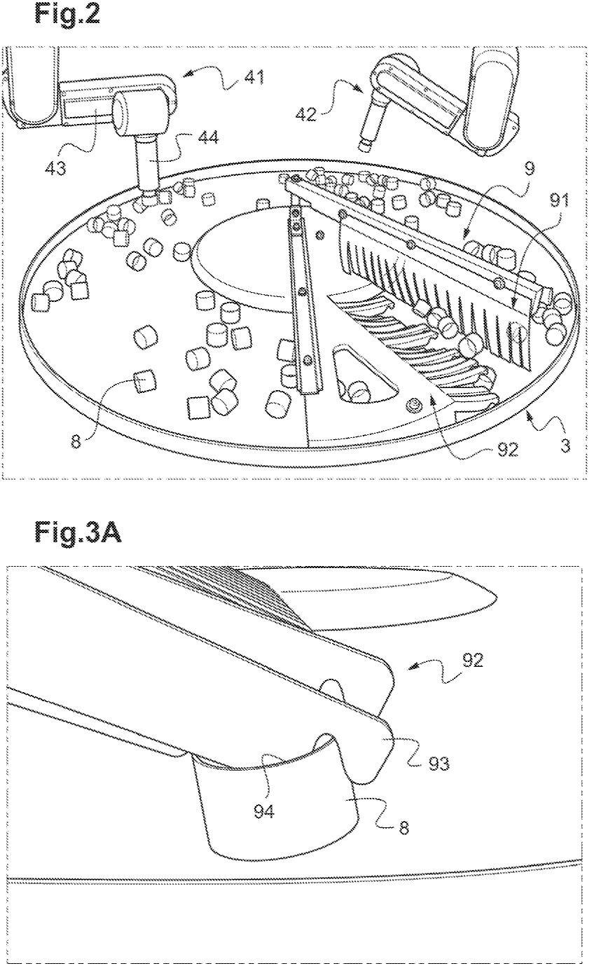

Reference is now made to FIG. 2, which illustrates an embodiment of the orientation means 9.

The orientation means 9 are integral with the frame of the system 1 for distributing closure elements 8.

More particularly, the turntable 3 is here arranged around the orientation means 9.

Alternatively, the orientation means 9 can be located on the periphery of the turntable 3.

The orientation means 9 include a flap 91 and a comb 92 arranged opposite each other and able, by cooperating, to orient the closure elements 8 according to the predetermined profile.

When it comes to screwing a closure element 8 onto a bottle, it is advantageous to orient according to said profile only the closure elements 8 which are arranged in the direction opposite to the screwing.

The profile here corresponds to a closure element 8 arranged on the turntable 3 in the direction of screwing.

Moreover, the term “comb” means any solid object including a plurality of more or less fine and tight teeth, used to grip the closure element by its hollow part.

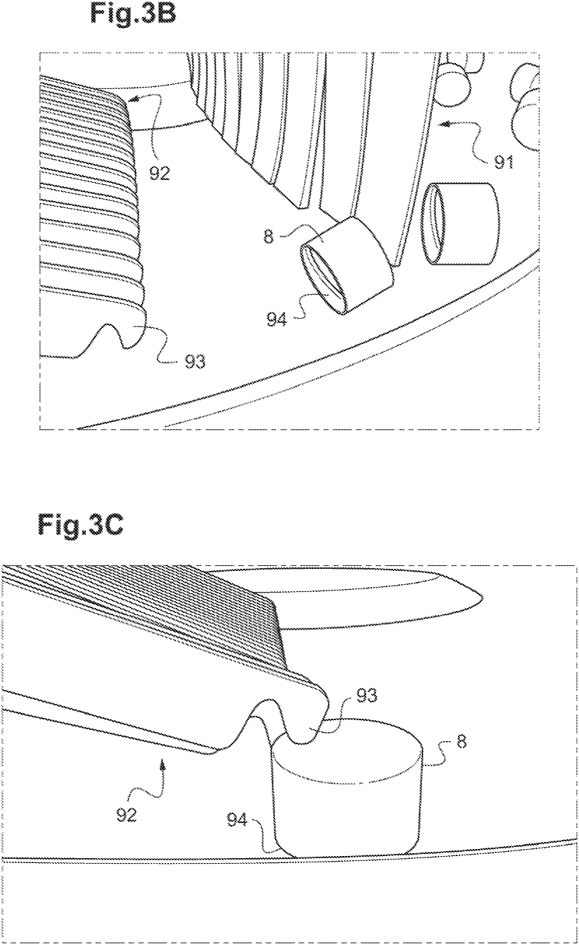

Thus, as illustrated in FIG. 3A, the comb 92 comprises a plurality of teeth 93 able to hook the closure element 8 by its hollow part 94.

As illustrated in FIG. 3B, the tooth 93 orients the closure element 8 at a first angle of 90°.

The closure element 8 then collides with the flap 91 able to orient it at a second angle of 90°.

Thus, by cooperating, the comb 92 and the flap 91 are able to orient the closure element 8 by an angle of 180° so that it is arranged in the direction of screwing.

The closure element 8 thus arranged is able to be gripped and transported by the gripping means 4 to the transfer means 6.

However, as shown in FIG. 3C, when the closure element 8 is arranged in the screwing direction, the tooth 93 cannot grip it.

Moreover, the invention is not limited to these embodiments and implementations but embraces all variants thereof. For example, the orientation means correspond to any device capable of orienting the closure elements according to a predetermined profile on a turntable.

1. An automated method for distributing closure elements with screwing and/or stopping means, comprising supplying a turntable with a plurality of closure elements arranged on the turntable characterised in that it comprises detecting the format of each closure element arranged on the turntable and gripping each closure element for which the format has been detected in order to distribute it to transfer means capable of transporting a plurality of closure elements with screwing and/or stopping means.

2. The method according to claim 1, further comprising an orientation of the closure elements arranged on the turntable according to a predefined profile.

3. The method according to claim 1 , wherein the turntable is supplied by the plurality of closure elements when the number of closure elements arranged on at least one surface of the turntable , is less than a predetermined threshold.

4. The method according to claim 1 , wherein the turntable is supplied with a plurality of closure elements when the total surface area covered by the closure elements arranged on at least one surface of the turntable is less than a predetermined threshold.

5. The method according to claim 1 , wherein the turntable is supplied cyclically.

6. The method according to claim 1, wherein the transfer means are initially in a reference position and wherein the transfer means are oriented by a reference angle relative to their reference position when they include a predefined number of closure elements other transfer means to be filled being simultaneously arranged in said reference position.

7. The method according to claim 1, wherein the detection comprises capturing an image of each closure element submitting the image to a classification algorithm able to select the format of the closure element from a set of possible reference formats.

8. The method according to claim 1 wherein the detection comprises capturing an image of each closure element and submitting the image to an image recognition algorithm able to detect a single closure element format.

9. An automated closure element distribution system with screwing and/or stopping means, comprising transfer means, a turntable, and supply means able to supply the turntable with a plurality of closure elements characterised in that it comprises:
- detection means capable of detecting the format of each closure element arranged on the turntable and,
- gripping means capable of gripping each closure element for which the format has been detected and placing it in transfer means capable of transporting a plurality of closure elements to the storage means.

10. The system according to claim 9, comprising orientation means capable of positioning the closure elements arranged on the turntable according to a predefined profile.

11. The system according to claim 10, wherein the orientation means include a comb and a flap arranged opposite each other.

12. The system according to claim 9 wherein the supply means are capable of supplying the turntable when the number of closure elements arranged on at least one surface of the turntable is less than a predetermined threshold.

13. The system according to claim 9 wherein the supply means are capable of supplying the turntable with a plurality of closure elements when the total surface area covered by the closure elements arranged on at least one surface of the turntable is less than a determined threshold.

14. The system according to claim 9 wherein the supply means are capable of cyclically supplying the turntable with the plurality of closure elements.

15. The system according to claim 9 wherein the transfer means are initially in a reference position the system comprising control means able to orient the transfer means by a reference angle relative to their reference position when they include a predefined number of closure elements and simultaneously have other transfer means to be loaded in the reference position.

16. The system according to claim 9 comprising a calculation module and wherein the detection means (5) include at least one camera capable of capturing an image of a closure element submitting it to the calculation module able to select, by executing a classification algorithm, the closure element format from a set of possible reference formats.

17. The system according to claim 9 comprises a calculation module and wherein the detection means include at least one camera capable of capturing an image of a closure element and submitting it to the calculation module capable of detecting, by executing an image recognition algorithm, a single closure element format.

18. The system according to claim 9 wherein the gripping means include a suction cup and a centring jig, or a pneumatic or electric gripper.

19. The system according to claim 9 wherein the supply means include a lifting hopper andat least one conveyor capable of cooperating with the turntable.
